(19) United States
(12) Patent Application Publication
(10) Pub. No.: US 2005/0129269 A1
(43) Pub. Date: Jun. 16, 2005

(54) Context watermark for digital contents

(76) Inventor: Jyh-Han Lin, Coral Springs, FL (US)

Correspondence Address: Scott M. Garrett;Motorola, Inc., Law Department, 8000 West Sunrise Boulevard, Fort Lauderdale, FL, 33322, US

(21) Appl. No.: 10/732,044

(22) Filed: Dec. 10, 2003

(51) Int. Cl. H04K 3/00

(52) U.S. Cl. 382/100; 380/1

(57) ABSTRACT

A method for context watermarking includes the steps of performing a Hash function “D” of the digital content (502). A Hash function “C” of the context information is also calculated (504). The Hash “D” is then appended to the context information (506) while the Hash “C” is appended to the digital content (508). The augmented content and context information are then packaged together (510) with the Hash values “D” and “C” helping to bind the content and context together. Instead of using Hash function other more sophisticated signatures can be used like those produced using Discrete Wavelet Transforms (DWT) or fractal-based transforms. An electronic device such as a radio communication device (700) capable of performing context watermarking is also described.

### TECHNICAL FIELD

This invention relates in general to the field of electronics and more specifically to context watermarking of digital contents.

### BACKGROUND

As more electronic devices like radio communication devices (e.g., cellular telephones) become capable of digital content capturing (e.g., recording voice notes, taking still images using a built-in camera or attachable camera, collecting video clips, etc.) it would be beneficial if context information like location, time and other environmental information of the digital capture is recorded along with the content information that is captured. Context information (e.g., location of captured content) is sometimes valuable to those recording a digital content like a still image, since the context information may add extra sentimental or other value to the person capturing the content.

Collecting context information along with the captured content requires a way of retaining the context information and help facilitate its processing as the contents get transferred and stored. It would also be beneficial if the way of retaining the context information provides privacy and security protection to prevent any non-authorized use of tampering of the context invention. Given this, a need exists in the art for a context watermarking technique and apparatus that can help address some of the problems mentioned above.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a flow diagram showing how capturing and context watermarking is performed in accordance with one embodiment of the invention.

FIG. 2 shows how context separation and content playback is performed in accordance with an embodiment of the invention.

FIG. 3 illustrates how streaming context watermarking is performed in accordance with an embodiment of the invention.

FIG. 4 shows how streaming content and context playback is performed in accordance with an embodiment of the invention.

FIG. 5 shows a flowchart highlighting some of the steps performed for context watermark insertion without encryption is performed in accordance with an embodiment of the invention.

FIG. 6 shows a flowchart highlighting how context watermarking with encryption is performed in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

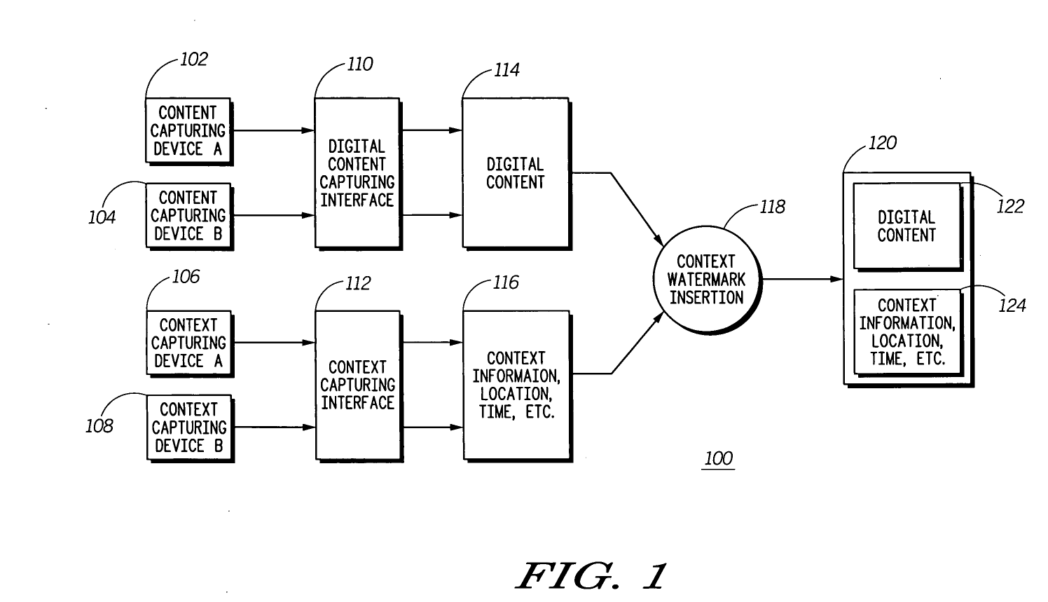

Referring now to FIG. 1, there is shown a flow diagram 100 showing how digital content capturing and context watermarking is performed in accordance with one embodiment of the invention. The present invention integrates digital watermark technology with content and context capturing mechanisms which can be located on an electronic device. The captured information can be encrypted for further security and also capturing can be preformed in either a still mode or a streaming mode.

Possible digital contents can include but are not limited to still images, video clips, voice recording, screen capturing or any other data capturing that can be digitized. Content capturing device A 102 and content capturing device B 104 can comprise but are not limited to digital camera, video recorder, microphone, etc.

Context capturing device A 106 and context capturing device B 108 collect context information that can include but is not limited to GPS location, time, capturing device characteristics, and other environmental variables such as lighting levels, temperature, etc. Some context capturing devices can include GPS receivers, temperature detectors, light meters, clocks, etc.

Coupled to the content capturing devices 102 and 104 is a digital content capturing interface 110 whose design will depend on the particular content capturing devices being utilized in a particular electronic device. The digital content capturing interface will provide any necessary hardware and/or software interface required to convert the captured content information into acceptable digital data which is stored in block 114.

The context capturing devices 106 and 108 will also have a context capturing interface 112 whose design will also depend on the type of context that is being captured. The context information such as location, time, etc. is stored in block 116. In block 118, the context watermark is inserted with the digital content 122 and context information 124 being stored in a combined format as well be explained below in block 120.

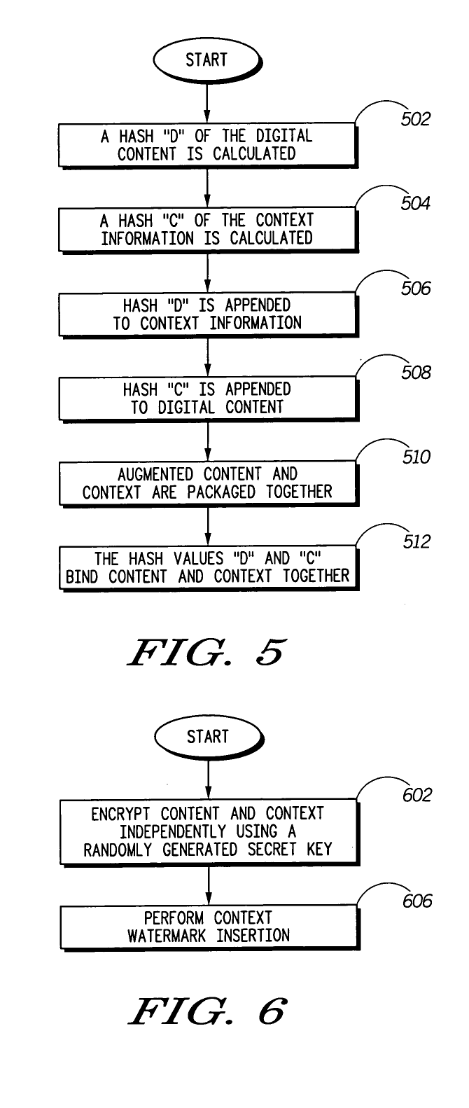

Referring now to FIG. 5, there is shown a flowchart on how the context watermark insertion of block 118 is performed in accordance with an embodiment of the invention. In step 502, a Hash function (referred to as “D”) of the digital content is calculated. In step 504, a Hash function (referred to as “C”) of the context information is calculated. In step 506, the Hash function “D” is appended to the context information, while in step 508, the Hash function “C” is appended to the digital content information. The augmented content and context are packaged together in step 510 (see block 118 in FIG. 1) and in step 512 (see block 120 in FIG. 1), the Hash function values “D” and “C” bind the content and context information together.

It should be noted that although Hash functions are used in the described embodiment, other techniques such as using Discrete Wavelet Transforms (DWTs) or fractional-based transforms may also be used. These are ideally suited for video and audio respectively.

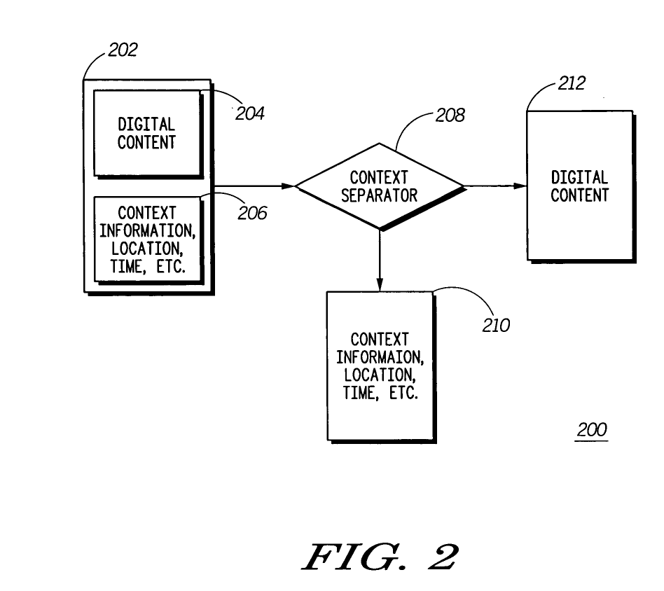

Referring now to FIG. 2, a simplified flow diagram 200 of how the context separation and content playback is performed is shown. The digital content 204 and context information that had been combined in block 202 as content with context watermark is sent to a context separator 208 which separates the context information 210 and the digital content information 212. The context separator 208 parses the combined package 202 of digital content 204 and context watermark information 206. For stationary digital content, the output is the digital content 212 and a separate context information watermark 210.

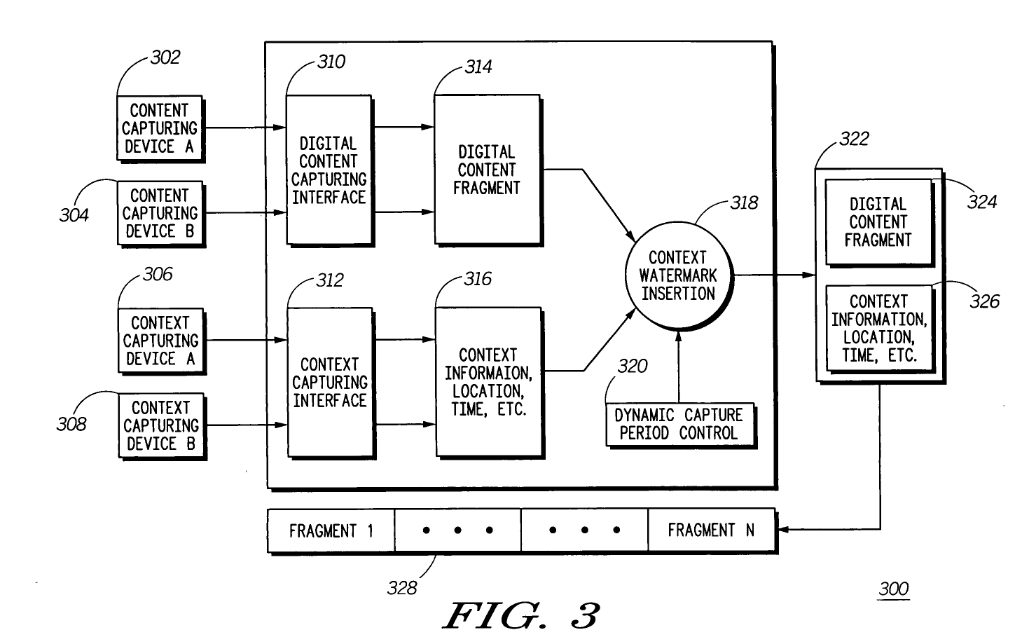

In FIG. 3, there is shown a block diagram highlighting the use of the context watermarking technique of the present invention in a streaming context environment. When digital contents are captured continuously the context information may change continuously as well. The context watermarking scheme is illustrated for a single unit but can be extended for continuous media types. Content capturing devices A 302 and B 304 are coupled to a digital content capturing interface 310, while context capturing devices A 306 and B 308 are coupled to a context capturing interface 312. Stored content fragments 314 and stored context information 316 are then combined in the context watermarking insertion block 318.

A dynamic capture period control block 320 provides information to the context watermarking block 318 regarding the desired capture period length. The context watermarking period can be predefined or adjusted dynamically based on how fast the context changes by the dynamic capture period control block 320. The combined digital content fragments 324 and the context information 326 stored in block 322 can be output as a string of fragments 328. The period determined by the dynamic capture period control block 320 in another embodiment can be determined solely based on how fast the the content changes or based on the streaming rate of the electronic device (i.e., vocoder rate that breaks the down the stream into logical blocks of data, etc.).

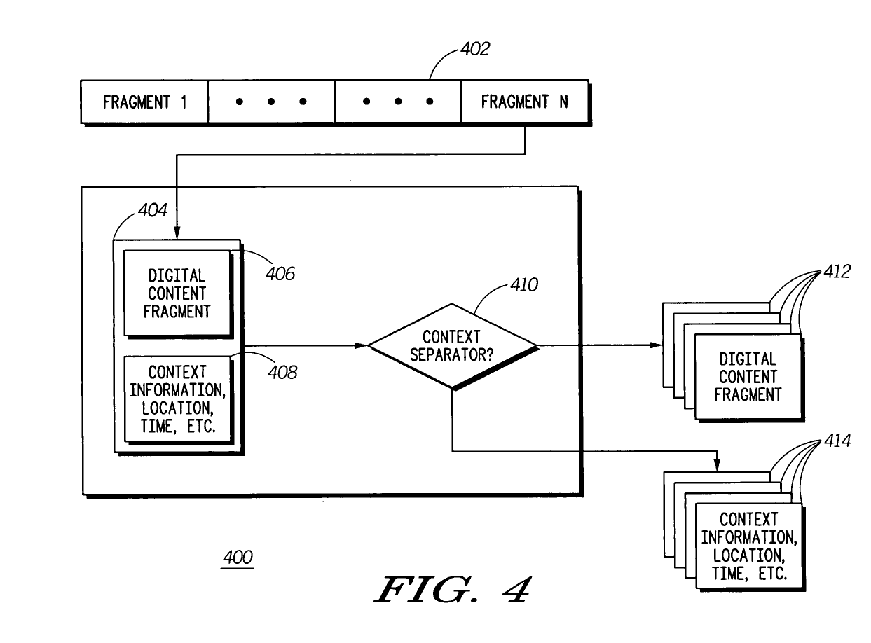

The playback for the streaming content and context is shown in FIG. 4. The fragments 402 are received and the digital content fragments 406 and the context information 408 are assembled in block 404. The context separator 410 outputs digital content fragment stream 412 and context information watermark stream 414.

The two streams 412 and 414 are separated by the context separator 410 while synchronized in playback.

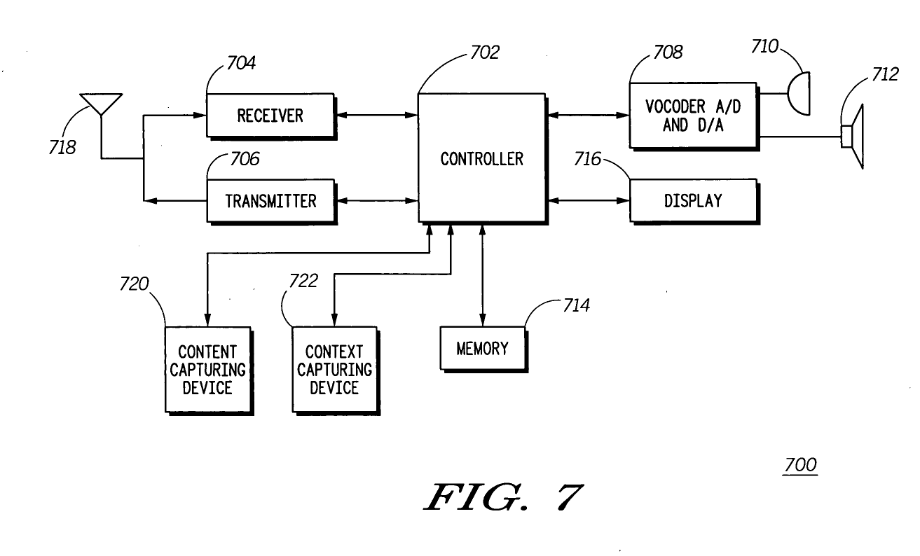

A further enhancement to the present invention is the ability to encrypt the content and/or the context information independently. When encryption is required due to the nature of the information, the content and/or the context is encrypted with a randomly generated key. The secret encryption key is encrypted using PKI technology and packaged with the content and/or context. After encryption, the context watermark insertion can proceed as previously described above. In FIG. 6, there is shown a flowchart highlighting the steps when performing encryption. In step 602, the content and/or context are encrypted independently using a randomly generated secret key. After encryption the context watermark insertion is performed in step 606 following the steps shown in the flowchart of FIG. 5. Although the above flowchart has shown the step of encrypting prior to watermarking, the steps can be reversed with the same security level being accomplished.

Referring now to FIG. 7, there is shown a block diagram of an electronic device such as a radio communication device 700 (e.g., cellular telephone) that can take advantage of the context watermarking of the present invention. Cellular telephone 700 includes an antenna 718 which is selectively coupled to a conventional receiver 704 and transmitter 706 sections. A controller, such as a microprocessor and/or Digital Signal Processor (DSP), provides the overall control for telephone 700. Memory 714 coupled to the controller 702 such as Random Access Memory (RAM), Read-Only Memory (ROM), FLASH, etc. stored all of the algorithms and variables needed by cellular telephone 700. A display 716 provides visual information to the cellular telephone user. An audio processing block 708 which can include a vocoder and Analog-to-Digital (A/D) and Digital-to-Analog (D/A) block provides all the necessary audio processing for both incoming and outgoing voice traffic. Coupled to the audio processing block 708 is a speaker 712 and microphone 710.

One or more content capturing devices 720 and one or more context capturing devices 722 are coupled to controller 702. Controller 702 performs all of the necessary steps previously described in order to provide the context watermark insertion and separation required by the present invention as well as any required encryption. Memory 714 stores all of the context and content information that has been received and processed.

The above described context watermarking technique provides for a simple way of retaining context information and facilitates its processing while the contents get transferred and stored. Added features include the ability to provide for streaming situations where the digital contents are captured continuously with the context information changing continuously by providing for a predefined or adjustable context watermarking period as provided by the dynamic capture period control 320. Extra security can also be provided by encrypting the content and/or context information.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for providing context information watermarking for digital content, comprising the steps of:
(a) calculating a transform function value “D” of the digital content;
(b) calculating a transform function value “C” of the context information;
(c) appending the transform function value “D” to the context information; and
(d) appending the transform function value “C” to the digital content.

2. A method as defined in claim 1, wherein the transform function used in steps (a)-(d) are Hash functions.

3. A method as defined in claim 1, wherein the transform function used in steps (a)-(d) is a Discrete Wavelet Transform (DWT).

4. A method as defined in claim 1, wherein the transform function used in steps (a)-(d) is a fractal-based transform

5. A method as defined in claim 2, further step of:
(e) packaging the results of steps (c) and (d) so that the Hash values “D” and “C” bind the content and context information together.

6. A method as defined in claim 3, further comprising the step of:
(f) encrypting the digital content.

7. A method as defined in claim 3, further comprising the step of:
(f) encrypting the context information.

8. A method as defined in claim 6, wherein the encrypting of step (f) is performed using a secret encryption key that is packaged with the digital content or the context information.

9. A method as defined in claim 2, wherein the period in which the context watermarking is performed is predefined.

10. A method as defined in claim 2, wherein the period in which the context watermarking is performed is adjusted dynamically based on how fast the context information is changing.

11. A method as defined in claim 10, wherein the dynamic adjustment of the context watermarking is performed using a dynamic capture period controller.

12. An electronic device that can perform context watermarking of digital content, comprising:
a content capturing device;
a context capturing device; and
a controller coupled to the content and context capturing devices, the controller calculates a transform function value “D” of the digital content received by the content capturing device and calculates a transform function value “C” of the context information captured by the context capturing device, it also appends the transform function value “D” to the context information and appends the transform function value “C” to the digital content.

13. An electronic device as defined in claim 12, wherein the controller further packages the results so that the transform function values “D” and “C” bind the content and context information together.

14. An electronic device as defined in claim 13, wherein the electronic device comprises a radio communication device.

15. An electronic device as defined in claim 13, wherein the controller also encrypts the context information or digital content.

16. An electronic device as defined in claim 13, further comprising a dynamic capture period control circuit coupled to the controller that adjusts dynamically the context watermarking based on how fast the context information is changing.

17. An electronic device as defined in claim 13, wherein the transform function used comprises a Hash function.

18. An electronic device as defined in claim 13, wherein the transform function used comprises a Discrete Wavelet Transform (DWT).

19. An electronic device as defined in claim 13, wherein the transform function used comprises a fractal-based transform.

20. A method for providing context watermarking in a radio communication device that captures both digital content and context information, comprising the steps of:
(a) calculating a hash function value “D” of the digital content;
(b) calculating a hash function value “C” of the context information;
(c) appending the hash function value “D” to the context information;
(d) appending the hash function value “C” to the digital content; and
(e) packaging the results of steps (c) and (d) so that the Hash values “D” and “C” bind the digital content and context information together.

21. A method as defined in claim 20, further comprising the step of:
(f) encrypting the context information.

22. A method as defined in claim 21, wherein the encrypting in step (f) is performed using a secret encryption key that is packaged with the digital content or the context information.
